(19) United States
(12) Patent Application Publication
(10) Pub. No.: US 2013/0246363 A1
(43) Pub. Date: Sep. 19, 2013

(54) IDLE POINT AUDITING FOR DATABASES

(71) Applicant: Ellen L. Sorenson, Mounds View, MN (US)

(72) Inventor: Ellen L. Sorenson, Mounds View, MN (US)

(21) Appl. No.: 13/420,940

(22) Filed: Mar. 15, 2012

(51) Int. Cl. G06F 17/30

(52) U.S. Cl. 707/648; 707/E17.007

(57) ABSTRACT

Idle points for a database, such as a database management system or a relational database management system (RDMS), may be marked in an audit log of a backup device coupled to the database. The backup device may receive an indication that the database has reached an idle point and verify the idle point through a data control system coupled to the database and the backup device. Once the idle point is verified, the idle point is logged in the audit log along with the date and time of the idle point. The idle point information may be used during recovery of the database from the backup device.

The instant disclosure relates to databases. More specifically, this disclosure relates to identifying idle points in databases.

### BACKGROUND

Database systems store large amounts of user data in a single location in an organized structure to allow rapid access. In particular, databases store user data from several users in a single system, which is accessed by all users. The number of users assessing a database may include tens, hundreds, or thousands of users. Thus, some database systems are continuously reading and writing user data.

Idle points, or quiescent points, in time are created for a database to allow certain operations to occur. An idle point is a point in time when the database is not utilized, such as when there are no pending requests for writing to the database. Understanding when idle points occur is important for performing certain maintenance work on the database, such as creating backups of the database. One difficulty with identifying idle points is the systems waiting for an idle point to perform maintenance on the database do not have knowledge of when an idle point occurs. For example, a backup device may be separate from a control system for providing users access to the database. Thus, the backup device does not have information regarding transactions pending for the database or when an idle point occurs.

### SUMMARY

According to one embodiment, a method includes determining when a database has reached an idle point. The method also includes verifying the idle point is reached. The method further includes when the idle point is verified, marking the idle point in an audit log.

According to another embodiment, a computer program product includes a non-transitory computer readable medium having code to determine when a database has reached an idle point. The medium also includes code to verify the idle point is reached. The method further includes code to mark the idle point in an audit log when the idle point is verified.

According to a further embodiment, an apparatus includes a memory storing an audit log and a processor coupled to the memory. The processor is configured to determine when a database has reached an idle point. The processor is also configured to verify the idle point is reached. The processor is further configured to mark the idle point in the audit log when the idle point is verified.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a block diagram illustrating a backup system for storing files in a database system according to one embodiment of the disclosure.

FIG. 2 is a flow chart illustrating a method of marking idle points in an audit log of a backup system according to one embodiment of the disclosure.

FIG. 3A is a flow chart illustrating a method of restoring a database from idle points according to one embodiment of the disclosure.

FIG. 3B is a flow chart illustrating a method of restoring a database from idle points according to another embodiment of the disclosure.

FIG. 4 is block diagram illustrating a computer network according to one embodiment of the disclosure.

FIG. 5 is a block diagram illustrating a computer system according to one embodiment of the disclosure.

FIG. 6A is a block diagram illustrating a server hosting an emulated software environment for virtualization according to one embodiment of the disclosure.

FIG. 6B is a block diagram illustrating a server hosing an emulated hardware environment according to one embodiment of the disclosure.

### DETAILED DESCRIPTION

Idle points may be stored in a log separate from the database by providing a method for verifying an idle point is created. For example, a backup device may receive an indication that an idle point has occurred. The backup device may then verify with a processing system connected to the database that an idle point has been reached. After the idle point is verified, the backup device may log the time and date of the idle point in an audit log.

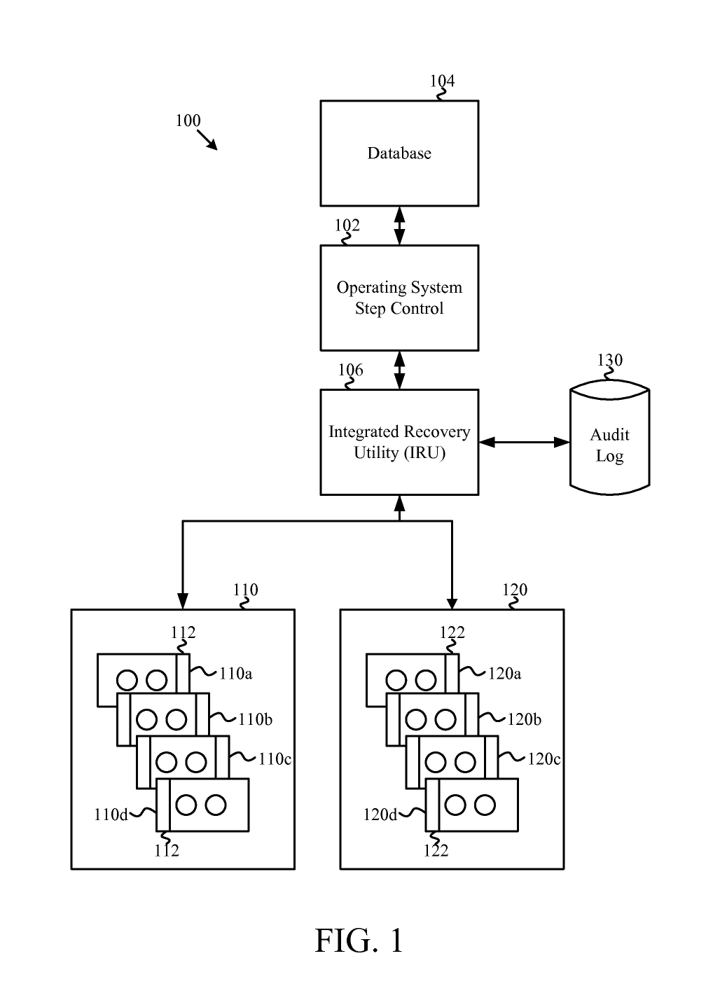

FIG. 1 is a block diagram illustrating a backup system for storing files in a database system according to one embodiment of the disclosure. A database 104 may be coupled to an integrated recovery utility (IRU) 106 for performing backups and/or recovery of a database file in the database 104. The database 104 may be, for example, a network database system (DMS), a relational database management system (RDMS), a transaction processing system (TIP), or the like, or a combination of database systems. An operating system step control 102 may be coupled to the database 104 and the IRU 106 to control backup and/or other file operations. The IRU 106 may create backups of the database 104 under control of the operating system step control 102. The operating system step control 102 may be a software module operating in an operating system.

The IRU 106 may have access to a first backup 110 and a second backup 120. The first backup 110 may include a number of drives 110a-d, such as tapes that store a backup of the database 104. Data stored on the drives 110a-d include a default set 112 having history information for the first backup 110. The history information may include, for example, links between the drives 110a-d identifying the starts and ends of files. Although the default set 112 is illustrated as stored across the drives 110a-d, the default set 112 may be stored on only one or a few of the drives 110a-d or may be stored on a separate storage device (not shown). According to one embodiment, the default set 112 may be stored in memory within the IRU 106.

The second backup 120 may include a number of drives 120a-d, which may or may not be identically-configured storage devices to the drives 110a-d of the first backup 110. According to one embodiment, the drives 120a-d may be virtualized drives. The second backup 120 may be located remote to the first backup 110. Thus, the second backup 120 may provide an off-site backup to decrease the likelihood that both the first backup 110 and the second backup 120 are lost simultaneously. The second backup 120 may include an alternate set 122 stored on the drives 120a-d having history information for the second backup 120. Because the drives 120a-d may be different than the drives 110a-d, the alternate set 122 may be different from the default set 112. For example, when the drives 120a-d have different storage capacities than the drives 110a-d, the links for files stored on the drives 120a-d contained in the alternate set 122 may link to different locations within the drives 120a-d than contained in the default set 112. According to one embodiment, the drives 120a-d may be virtualized drives.

An audit log 130 may be stored by the IRU 106. The audit log 130 may store information regarding modifications to the database 104. For example, the audit log 130 may include entries when files are created, modified, and/or deleted in the database 104. The audit log 130 may also include other events occurring within the IRU 106. For example, the audit log 130 may include startup and shutdown of the IRU 106 and recovery operations performed by the IRU 106, such as when the IRU 106 restores data to the database 104. The audit log 130 may further include information about a user creating the event, such as the user that modifies the database 104. An example entry in the audit log 130 may be: “MODIFY FILE1 02/01/10 14:22 USER_JOE.”

The audit log 130 may also include logged events marking idle points for the database 104. An idle point occurs when there are no outstanding operations pending for the database 104. Idle points may be marked in the audit log 130 and used in future recovery processes. An example entry in the audit log 130 may be: “DB IDLE 02/01/10 14:25.”

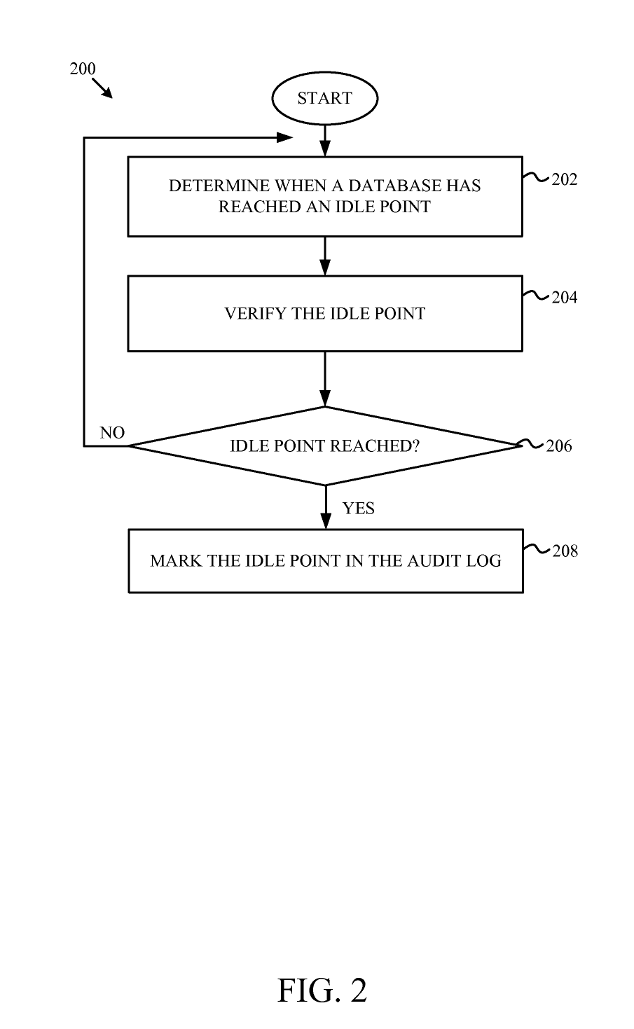

FIG. 2 is a flow chart illustrating a method of marking idle points in an audit log of a backup system according to one embodiment of the disclosure. A method 200 begins at block 202 with determining when a database has reached an idle point. The idle point may be determined by receiving input from a user. For example, a user may instruct the IRU 106 to mark an idle point in the audit log 130 for the database 104. Because the IRU 106 may not have access to pending requests for the database 104, the idle point determination may be verified by the operating system step control 102.

At block 204, the idle point is verified. The IRU 106 may verify the database 104 has reached an idle point. For example, the IRU 106 may communicate with the operating system step control 102 to determine if there are no pending requests to modify data in the database 104. If the idle point is verified as reached at block 206, the method 200 continues to block 208. If the idle point is not verified as reached at block 206, the method 200 returns to block 202 to wait for another indication that an idle point is reached. Alternatively, when the idle point is not verified, a user may be immediately notified of the idle point failure.

At block 208, the idle point is marked in the audit log. Idle points may be marked in the audit log 130 and used in future recovery processes. An example entry in the audit log 130 may be: “DB IDLE 02/01/10 14:25.” According to one embodiment, after the idle point is marked in the audit log 130, the IRU 106 may take an additional action, such as initiating the creation of a new backup. When the idle point is determined at block 202 from a user input, a report may be generated to the user indicating the successful creation of the idle point and logging of the idle point. The idle point may also be logged in a history file corresponding to the backups 110 and 120, such as the set information 112 and 122.

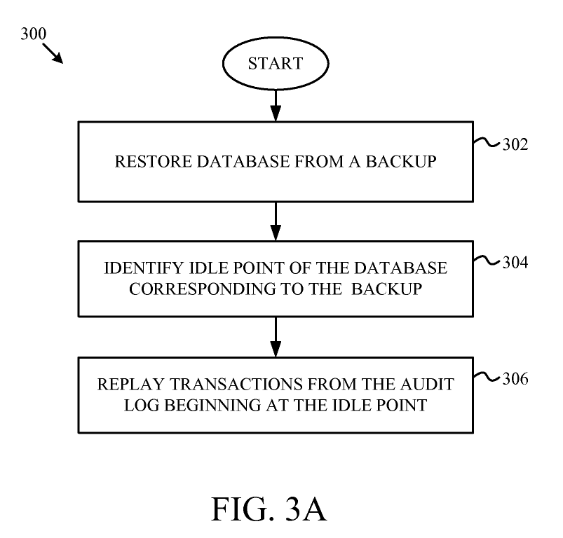

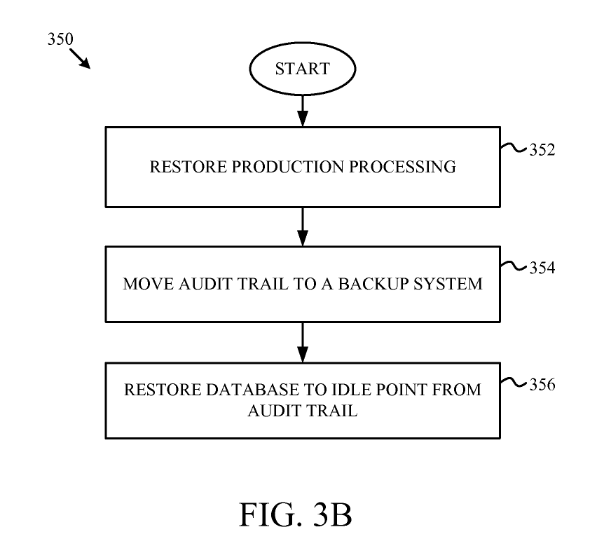

FIG. 3A is a flow chart illustrating a method of restoring a database from idle points according to one embodiment of the disclosure. A method 300 begins at block 302 with restoring the database 104 from one of the backups 110, 120. At block 304, an idle point is identified in the audit log 130 corresponding to the backup restored at block 302. The audit log 130 may be played back, beginning at the idle point, to replay transactions performed on the database 104 after the idle point.

An idle point may also identify the end point of a recovery process. FIG. 3B is a flow chart illustrating a method of restoring a database from idle points according to another embodiment of the disclosure. A method 350 begins at block 352 with restoring production processing. At block 354, an audit trail is moved to a backup system. Blocks 354 and 352 may be performed in parallel. At block 356, the database is restored up to an idle point previously marked for the database. Restoring a database up to an idle point provides a consistent database with no data loss up to the idle point. According to one embodiment, the recovery on the backup database up to the idle point may be initiated before the idle point is created.

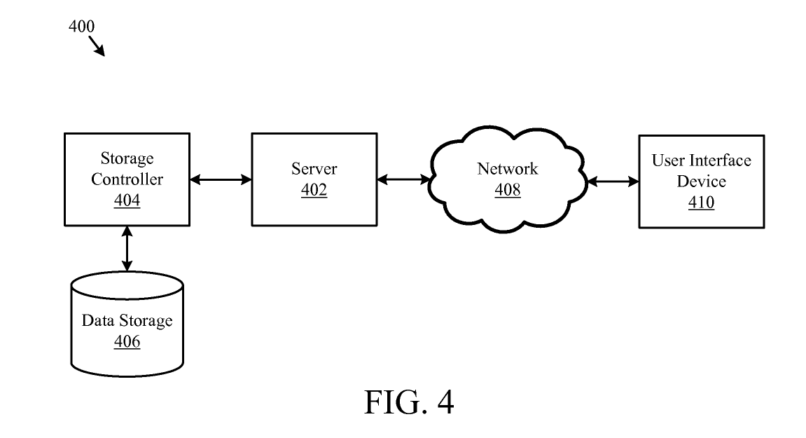

FIG. 4 illustrates one embodiment of a system 400 for an information system, such as a system for backing up databases. The system 400 may include a server 402, a data storage device 406, a network 408, and a user interface device 410. The server 402 may be a dedicated server or one server in a cloud computing system. In a further embodiment, the system 400 may include a storage controller 404, or storage server configured to manage data communications between the data storage device 406 and the server 402 or other components in communication with the network 408. In an alternative embodiment, the storage controller 404 may be coupled to the network 408.

In one embodiment, the user interface device 410 is referred to broadly and is intended to encompass a suitable processor-based device such as a desktop computer, a laptop computer, a personal digital assistant (PDA) or tablet computer, a smartphone or other a mobile communication device having access to the network 408. When the device 410 is a mobile device, sensors (not shown), such as a camera or accelerometer, may be embedded in the device 410. When the device 410 is a desktop computer the sensors may be embedded in an attachment (not shown) to the device 410. In a further embodiment, the user interface device 410 may access the Internet or other wide area or local area network to access a web application or web service hosted by the server 402 and provide a user interface for enabling a user to enter or receive information.

The network 408 may facilitate communications of data, such as authentication information, between the server 402 and the user interface device 410. The network 408 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate.

In one embodiment, the user interface device 410 accesses the server 402 through an intermediate sever (not shown). For example, in a cloud application the user interface device 410 may access an application server. The application server fulfills requests from the user interface device 410 by accessing a database management system (DBMS). In this embodiment, the user interface device 410 may be a computer or phone executing a Java application making requests to a JBOSS server executing on a Linux server, which fulfills the requests by accessing a relational database management system (RDMS) on a mainframe server.

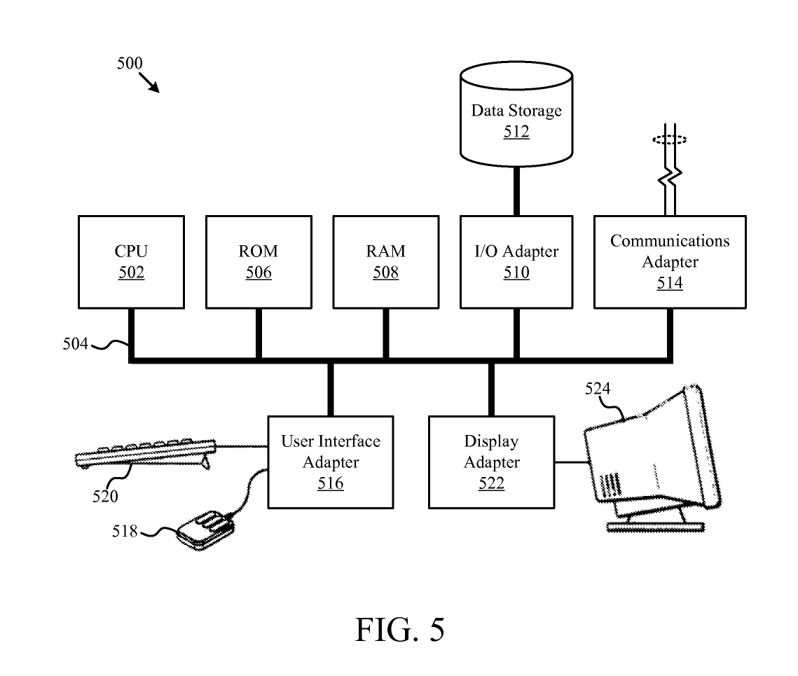

FIG. 5 illustrates a computer system 500 adapted according to certain embodiments of the server 402 and/or the user interface device 410. The central processing unit (“CPU”) 502 is coupled to the system bus 504. The CPU 502 may be a general purpose CPU or microprocessor, graphics processing unit (“GPU”), and/or microcontroller. The present embodiments are not restricted by the architecture of the CPU 502 so long as the CPU 502, whether directly or indirectly, supports the operations as described herein. The CPU 502 may execute the various logical instructions according to the present embodiments.

The computer system 500 also may include random access memory (RAM) 508, which may be synchronous RAM (SRAM), dynamic RAM (DRAM), synchronous dynamic RAM (SDRAM), or the like. The computer system 500 may utilize RAM 508 to store the various data structures used by a software application. The computer system 500 may also include read only memory (ROM) 506 which may be PROM, EPROM, EEPROM, optical storage, or the like. The ROM may store configuration information for booting the computer system 500. The RAM 508 and the ROM 506 hold user and system data.

The computer system 500 may also include an input/output (I/O) adapter 510, a communications adapter 514, a user interface adapter 516, and a display adapter 522. The I/O adapter 510 and/or the user interface adapter 516 may, in certain embodiments, enable a user to interact with the computer system 500. In a further embodiment, the display adapter 522 may display a graphical user interface (GUI) associated with a software or web-based application on a display device 524, such as a monitor or touch screen.

The I/O adapter 510 may couple one or more storage devices 512, such as one or more of a hard drive, a solid state storage device, a flash drive, a compact disc (CD) drive, a floppy disk drive, and a tape drive, to the computer system 500. According to one embodiment, the data storage 512 may be a separate server coupled to the computer system 500 through a network connection to the I/O adapter 510. The communications adapter 514 may be adapted to couple the computer system 500 to the network 408, which may be one or more of a LAN, WAN, and/or the Internet. The communications adapter 514 may also be adapted to couple the computer system 500 to other networks such as a global positioning system (GPS) or a Bluetooth network. The user interface adapter 516 couples user input devices, such as a keyboard 620, a pointing device 518, and/or a touch screen (not shown) to the computer system 500. The keyboard 520 may be an on-screen keyboard displayed on a touch panel. Additional devices (not shown) such as a camera, microphone, video camera, accelerometer, compass, and or gyroscope may be coupled to the user interface adapter 516. The display adapter 522 may be driven by the CPU 502 to control the display on the display device 524. Any of the devices 502-522 may be physical, logical, or conceptual.

The applications of the present disclosure are not limited to the architecture of computer system 500. Rather the computer system 500 is provided as an example of one type of computing device that may be adapted to perform the functions of a server 402 and/or the user interface device 410. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 600 may be virtualized for access by multiple users and/or applications.

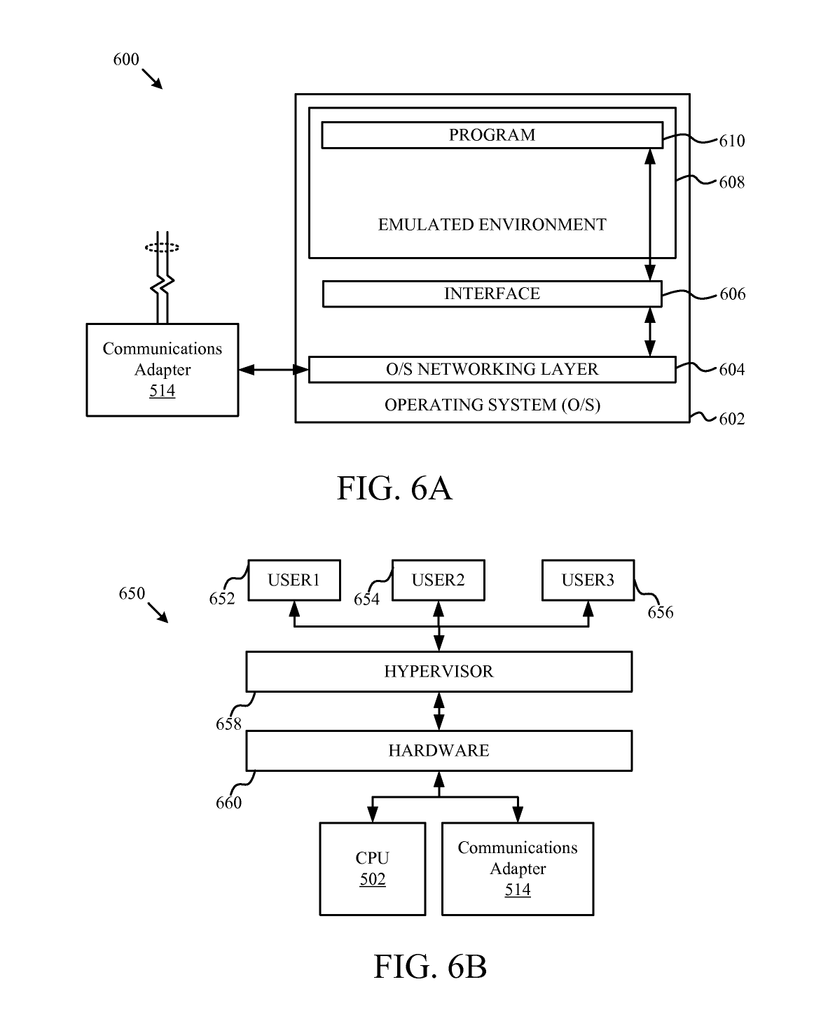

FIG. 6A is a block diagram illustrating a server hosting an emulated software environment for virtualization according to one embodiment of the disclosure. An operating system 602 executing on a server includes drivers for accessing hardware components, such as a networking layer 604 for accessing the communications adapter 514. The operating system 602 may be, for example, Linux. An emulated environment 608 in the operating system 602 executes a program 610, such as CPCommOS. The program 610 accesses the networking layer 604 of the operating system 602 through a non-emulated interface 606, such as XNIOP. The non-emulated interface 606 translates requests from the program 610 executing in the emulated environment 608 for the networking layer 604 of the operating system 602.

In another example, hardware in a computer system may be virtualized through a hypervisor. FIG. 6B is a block diagram illustrating a server hosing an emulated hardware environment according to one embodiment of the disclosure. Users 652, 654, 656 may access the hardware 660 through a hypervisor 658. The hypervisor 658 may be integrated with the hardware 660 to provide virtualization of the hardware 660 without an operating system, such as in the configuration illustrated in FIG. 6A. The hypervisor 658 may provide access to the hardware 660, including the CPU 502 and the communications adaptor 514.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
determining when a database has reached an idle point;
verifying the idle point is reached; and
when the idle point is verified, marking the idle point in an audit log.

2. The method of claim 1, in which the verifying step comprises querying an operating system step control coupled to the database to verify the database has reached the idle point.

3. The method of claim 2, in which the database is at least one of a relational database management system (RDMS), a network database management system, and a transaction processor.

4. The method of claim 1, in which the step of marking the idle point comprises storing a date and time of the idle point.

5. The method of claim 1, in which the determining step comprises receiving a request to mark the idle point when the idle point is reached.

6. The method of claim 1, further comprising creating a backup of the database with an integrated recovery utility (IRU) after the idle point is verified.

7. The method of claim 6, further comprising restoring the database from the backup and the audit log from the idle point after creating the backup.

8. A computer program product, comprising:
a non-transitory computer readable medium comprising:
code to determine when a database has reached an idle point;
code to verify the idle point is reached; and
code to mark the idle point in an audit log when the idle point is verified.

9. The computer program product of claim 8, in which the medium further comprises code to query an operating system step control coupled to the database to verify the database has reached the idle point.

10. The computer program product of claim 9, in which the database is at least one of a relational database management system (RDMS), a network database management system, and a transaction processor.

11. The computer program product of claim 8, in which the medium further comprises code to store a date and time of the idle point.

12. The computer program product of claim 8, in which the medium further comprises code to receive a request to mark the idle point when the idle point is reached.

13. The computer program product of claim 8, in which the medium further comprises code to create a backup of the database with an integrated recovery utility (IRU).

14. The computer program product of claim 13, in which the medium further comprises code to restore the database from the backup and the audit log from the idle point.

15. An apparatus, comprising:
a memory storing an audit log; and
a processor coupled to the memory, in which the processor is configured:
to determine when a database has reached an idle point;
to verify the idle point is reached; and
to mark the idle point in the audit log when the idle point is verified.

16. The apparatus of claim 15, in which the processor is further configured to query an operating system step control coupled to the database to verify the database has reached the idle point.

17. The apparatus of claim 16, in which the database is at least one of a relational database management system (RDMS), a network database management system, and a transaction processor.

18. The apparatus of claim 15, in which the processor is further configured to store a date and time of the idle point.

19. The apparatus of claim 15, in which the processor is further configured to receive a request to mark the idle point when the idle point is reached

20. The apparatus of claim 15, in which the processor is further configured to create a backup of the database with an integrated recovery utility (IRU).
